(19) United States
(12) Patent Application Publication
(10) Pub. No.: US 2008/0112486 A1
(43) Pub. Date: May 15, 2008

(54) Encoding apparatus and encoding method

(75) Inventors: Masashi Takahashi, Yokohama (JP); Tomokazu Murakami, Kokubunji (JP); Hiroaki Ito, Yokohama (JP); Isao Karube, Fujisawa (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/979,773

(22) Filed: Nov. 8, 2007

(30) Foreign Application Priority Data
Nov. 13, 2006 (JP) 2006-306135

(51) Int. Cl. H04N 7/32

(52) U.S. Cl. 375/240.12; 375/E07.243

(57) ABSTRACT

The calculation processing amount of encoding processing is reduced while suppressing a decrease in encoding efficiency. An encoding method includes the steps of generating predicted image data from an image of a predetermined reference frame; generating differential image data from a difference between the predicted image data and image data of one frame of the input image data; performing discrete cosine transformation processing and quantization processing for the differential image data for generating encoded image data; performing variable-length encoding processing for the encoded image data for generating an encoded stream; and performing reference frame update determination processing in which a correlation between the image of the reference frame and the image of the one frame is determined for deciding whether or not the one frame is to be used as a new reference frame.

### INCORPORATION BY REFERENCE

The present application claims priority from Japanese application JP2006-306135 filed on Nov. 13, 2006, the content of which is hereby incorporated by reference into this application.

### BACKGROUND OF THE INVENTION

1. Field of the Invention

The present invention relates to a technology for encoding a moving image.

2. Description of the Related Art

In the encoding technology in which predictive images are generated from reference images for encoding a moving image, a technology, such as the one disclosed in US2006/0171680 (corresponding to JP-A-2006-217180), is known for determining whether or not an image is to be deleted from the reference image memory.

### SUMMARY OF THE INVENTION

However, when inter-screen prediction is performed for a slow-moving video or a video with little movement in the prior art, always using the temporally closest image as the reference frame of the video generates a problem that the reference frame update processing involves an amount of calculation that is redundant.

On the other hand, using a temporally distant image as the reference frame of a fast-moving video or a video with large movement generates a problem that the encoding efficiency is significantly decreased.

In view of the fore going, the present invention reduces the amount of calculation processing in the encoding processing while suppressing a decrease in encoding efficiency.

One embodiment of the present invention comprise the steps of generating predicted image data from an image of a predetermined reference frame; generating differential image data from a difference between the predicted image data and image data of one frame of the input image data; performing discrete cosine transformation processing and quantization processing for the differential image data for generating encoded image data; performing variable-length encoding processing for the encoded image data for generating an encoded stream; and performing reference frame update determination processing in which a correlation between the image of the reference frame and the image of the one frame is determined for deciding whether or not the one frame is to be used as a new reference frame.

The above configuration controls whether or not the reference frame update processing is to be performed and reduces the amount of calculation processing during the encoding processing while suppressing a decrease in encoding efficiency.

The present invention can reduce the amount of calculation processing during the encoding processing while suppressing a decrease in encoding efficiency.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of an image encoding apparatus in one embodiment of the present invention.

FIG. 2 is a block diagram showing an example of a reference frame update determination processing unit in one embodiment of the present invention.

FIG. 3 is a block diagram showing an example of an image encoding apparatus in one embodiment of the present invention.

FIG. 4 is a block diagram showing an example of a reference frame update determination processing unit in one embodiment of the present invention.

FIG. 5A is a diagram showing a conventional image encoding method.

FIG. 5B is a diagram showing an example of an image encoding method in one embodiment of the present invention.

FIG. 6A is a diagram showing a conventional image encoding method.

FIG. 6B is a diagram showing an example of an image encoding method in one embodiment of the present invention.

FIG. 6C is a diagram showing an example of an image encoding method in one embodiment of the present invention.

FIG. 6D is a diagram showing an example of an image encoding method in one embodiment of the present invention.

FIG. 6E is a diagram showing an example of an image encoding method in one embodiment of the present invention.

FIG. 7 is a diagram showing an example the flow of image encoding processing in one embodiment of the present invention.

FIG. 8 is a diagram showing an example the flow of image encoding processing in one embodiment of the present invention.

FIG. 9A is a diagram showing an example of image encoding processing in one embodiment of the present invention.

FIG. 9B is a diagram showing an example of the relation between a reference frame and an encoding frame in one embodiment of the present invention.

FIG. 10 is a diagram showing an example of image encoding processing in one embodiment of the present invention.

### DETAILED DESCRIPTION OF THE EMBODIMENTS

While we have shown and described several embodiments in accordance with our invention, it should be understood that disclosed embodiments are susceptible of changes and modifications without departing from the scope of the invention. Therefore, we do not intent to be bound by the details shown and described herein but intend to cover all such changes and modifications a fall within the ambit of the appended claims.

Embodiments of the present invention will be described below with reference to the drawings.

In all of the drawings, the same reference numeral is given to components having the same function.

The expression “update processing” or “reference frame update processing” used in the description and the drawings of this specification refers to the processing for storing, holding, or saving target image data in the memory or the storage unit, in which reference image data is held, as reference image data. In this case, the reference image data, which has been held in the memory or the storage unit, may or may not be discarded or erased.

An I-picture used in the description and the drawings of this specification refers to a frame encoded with no reference to other frames.

A P-picture used in the description and the drawings of this specification refers to a frame encoded with reference to a frame that is a past frame of the encoding frame. That is, a P-picture is a frame encoded through forward prediction.

A B-picture used in the description and the drawings of this specification refers to a frame encoded with reference to a frame that is a past frame and a future frame of the encoding frame. That is, a B-picture is a frame encoded through bi-directional prediction.

A frame simply called a “next frame” in the description and the drawings of this specification refers to a temporally immediately following frame.

### First Embodiment

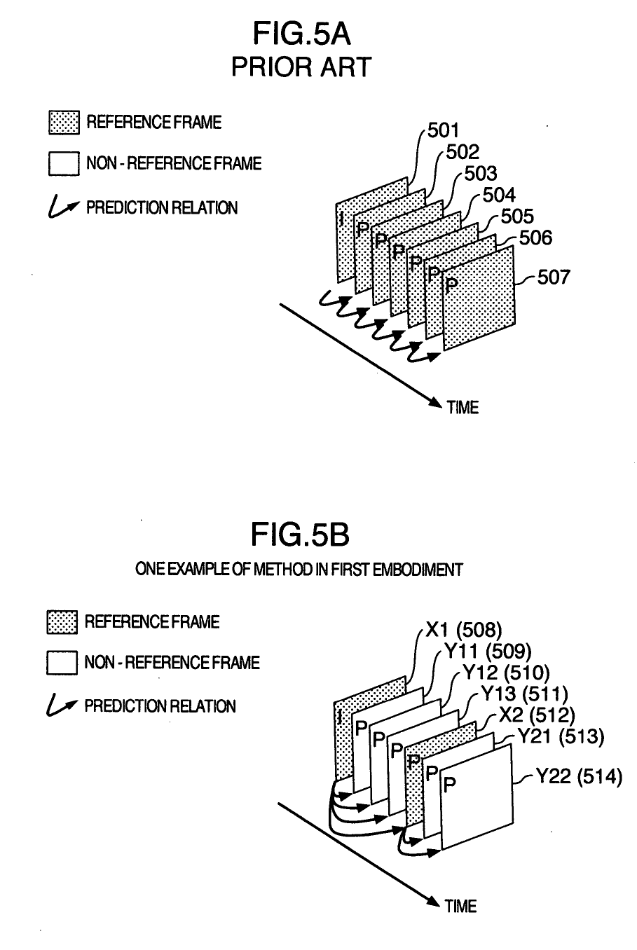

First, the following describes a first embodiment of the present invention with reference to the drawings. FIG. 5A and FIG. 5B show multiple frames included in moving-image data. FIG. 5A shows an example of the operation of encoding processing in the prior art, and FIG. 5B shows an example of the operation of encoding processing in the first embodiment of the present invention. The picture type is indicated in each frame. An arrow shown in the figure indicates the prediction relation when data is encoded. An arrow indicates that a predicted image for encoding the frame at the end point of the arrow is generated with the frame at the start point of the arrow as the reference image. As shown in FIG. 5A and FIG. 5B, I-pictures and P-pictures are used, but B-pictures are not used, as the picture structure in the first embodiment of the present invention.

Referring to frames (501)-(507) in FIG. 5A, the following describes a case in the prior art in which the image temporally closest to the encoding image is always used as the reference frame. In this case, a P-picture always references the immediately preceding image, for example, the frame (501) is referenced by the next frame (502), the frame (502) is referenced by the next frame (503), and so on. This method requires that the reference frame be updated after encoding each picture. So, this results in more frequent update processing and a larger amount of update processing. Especially, when the target encoding frame is a slow-moving scene or a scene with little movement and there is little or no change in the images in frames (501)-(503), the amount of update processing is increased but there is almost no change in the encoding efficiency when frame (502) and frame (503) are generated as a new reference image. In such a case, the calculation processing amount can be reduced.

To solve this problem, the method in this embodiment determines whether or not update processing is necessary for a reference frame according to the characteristics of a moving image, and reduces the calculation processing amount during the encoding processing while suppressing a decrease in encoding efficiency.

The following describes this method with the frames (508)-(514) in FIG. 5B as an example. First, the frame (508), the first frame, is encoded as an I-picture without referencing other frames. Next, the frame (509) is encoded as a P-picture by referencing the immediately preceding frame (508). After that, the correlation between the target encoding frame (509) and the reference frame (508) is determined. If it is found that the correlation is high, that is, if there is a small change between the frames, the update processing is not performed judging that there is not much effect in updating the reference frame. In this case, the next frame (510) is encoded using the same reference frame (508) as that of the frame (509). After encoding the frame (510), the correlation between the target encoding frame (510) and the reference frame (508) is also determined. This processing is repeated using the same reference frame (508) for encoding until it is determined that the correlation between the target encoding frame and the reference frame is low. For example, assume that, as a result of encoding the frame (512) by referencing the frame (508), the correlation between the frame (512) and the reference frame is determined to be low. In this case, the reference frame update processing is performed for the frame (512) and the subsequent frames, frame (513) and frame (514), are encoded by referencing the frame (512).

The processing described above reduces the amount of reference frame update processing and, so, reduces the amount of processing required for encoding. For example, in the encoding processing in the prior art shown in FIG. 5A, the update processing is performed each time the encoding processing for each of the frames (frame (502), frame (503), frame (504), frame (505), frame (506), and frame (507)) is finished and, in this case, the reference frame update processing is performed a total of six times. In contrast, in the encoding processing from frame (508) to frame (514) in FIG. 5B, the reference frame update processing is performed only once after encoding the frame (512).

The method described above uses the correlation between a reference frame and an encoding frame to determine whether the reference frame update processing is necessary, thus reducing the number of times the update processing is performed.

When an encoded stream is generated using one example of the encoding processing method shown in FIG. 5B described above, a characteristic encoded stream such as the one shown in FIG. 5B is generated in which at least one set of two P-pictures, whose reference frame is the same frame (for example, frame (508) in FIG. 5B) and which are temporally consecutive, is included.

When an encoded stream is generated using one example of the encoding processing method shown in FIG. 5B described above, that is, when a predetermined reference frame (for example, frame (508) in FIG. 5B) used for the forward prediction of other frames and multiple P-picture frames (for example, frame (509), frame (510), and frame (511) in FIG. 5B) that are not the reference frame of other pictures are temporally consecutive from the reference frame, a characteristic encoded stream is generated in which each of the multiple P-picture frames is encoded by referencing the predetermined reference frame.

At this time, when the frame (for example, frame (512) in FIG. 5B) that is temporally immediately after the multiple P-picture frames (for example, frame (509), frame (510), and frame (511) in FIG. 5B) is a P-picture frame, a characteristic encoded stream is generated in which the P-picture frame references the predetermined reference frame (for example, frame (508) in FIG. 5B).

The correlation determination method will be described in detail later.

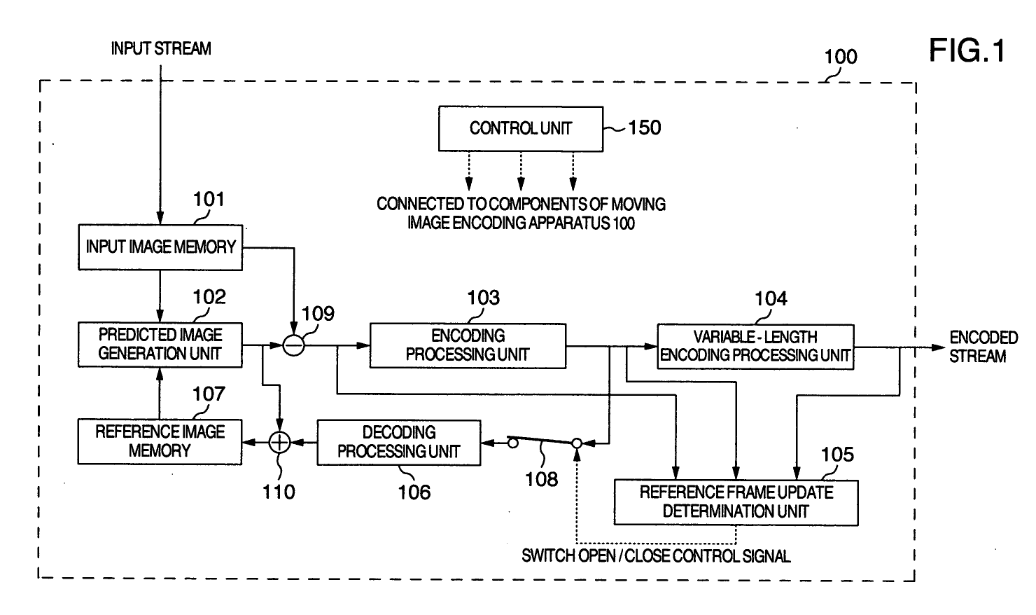

Next, the following describes an example of a moving image encoding apparatus in this embodiment with reference to FIG. 1. In the configuration in FIG. 1, a moving image is encoded using the picture structure composed of pictures whose picture type is an I-picture and pictures whose picture type is a P-picture.

For example, a moving image encoding apparatus (100) comprises an input image memory (101) in which input image data is held, a predicted image generation unit (102) that performs intra-screen prediction or inter-screen prediction for input image data, one block at a time, for generating predicted image data, a subtracter (109) that calculates the difference between predicted image data and input image data to generate differential image data, an encoding processing unit (103) that frequency-converts, quantizes, and encodes differential image data, a variable-length encoding unit (104) that efficiently encodes image data based on the generation probability of symbols, a reference frame update determination processing unit (105) that determines whether or not a reference frame is updated, a decoding processing unit (106) that de-quantizes and inverse-orthogonal transforms encoded differential image data for decoding, an adder (110) that combines decoded differential image data with predicted image data to generate reference image data, a reference image memory (107) that holds generated reference image data, a switch unit (108) that connects the reference frame update determination processing unit (105) and the decoding processing unit (106), and a control unit (150) that controls the components of the moving image encoding apparatus (100). A block is a small area generated by dividing an image. The variable-length encoding unit (104) is though of as an output unit that outputs an encoded stream.

The input image memory (101) holds input image data and sends it to the predicted image generation unit (102). The predicted image generation unit (102) divides the input image into blocks of predetermined size and selects an encoding mode, which maximizes the prediction efficiency, for each block from the pre-set encoding modes. That is, the predicted image generation unit (102) processes a part of the input image. Next, the predicted image generation unit (102) generates predicted image data in the selected encoding mode. An encoding mode refers to a combination of encoding methods, for example, the prediction method, block size, and pixel scan method, that can be switched from block to block.

Depending upon the encoding mode used, the predicted image generation unit (102) may acquire the reference image data, or a part, of a reference frame held in the reference image memory (107) and, using the acquired data, generates predicted image data. The predicted image generation unit (102) sends the generated predicted image data to the subtracter (109) and the adder (110).

Next, the subtracter (109) calculates the difference between the image data of the input image data or its part and the predicted image data on a pixel basis and generates differential image data. The subtracter (109) sends the generated differential image data to the encoding processing unit (103) and the reference frame update determination processing unit (105). The encoding processing unit (103) performs DCT (Discrete Cosine Transformation) processing and quantization processing for the acquired differential image data. The encoding processing unit (103) also sends the processed encoded image data to the variable-length encoding processing unit (104), reference frame update determination processing unit (105), and switch unit (108). In addition, the variable-length encoding processing unit (104) variable-length encodes the encoded image data based on the generation probability of symbols to generate an encoded stream and outputs the generated encoded stream outside the moving image encoding apparatus 100. The variable-length encoding processing unit (104) sends the encoded stream also to the reference frame update determination processing unit (105). The reference frame update determination processing unit (105) determines the picture type of the encoding frame from the acquired differential image data, encoded image data, or encoded stream. If the picture type is a P-picture, the reference frame update determination processing unit (105) calculates the prediction error value or the generation code amount of the encoding image. And, using the predetermined fixed determination criteria, statistical determination criteria, or local determination criteria, the reference frame update determination processing unit (105) determines the correlation between the encoding image and the reference frame. Based on the determined picture type and the correlation determination result, the reference frame update determination processing unit (105) sends the switch open/close control signal to the switch unit (108). At this time, if the picture type is an I-picture and if the picture type is a P-picture and the correlation is determined to be low, the reference frame update determination processing unit (105) sends the switch close signal. If the picture type is a P-picture and the correlation is determined to be high, the reference frame update determination processing unit (105) sends the switch open signal.

When the switch close signal is sent from the reference frame update determination processing unit (105), the switch unit (108) closes the switch to send the encoded image data to the decoding processing unit (106). The decoding processing unit (106) performs the inverse quantization processing and IDCT (Inverse DCT: Inverse Discrete Cosine Transformation) processing for the acquired encoded image data or the encoded stream, one block at a time, to decode it to the differential image data, and sends it to the adder (110). Next, the adder (110) combines the differential image data acquired from the decoding processing unit (106) and the predicted image data acquired from the predicted image generation unit (102) to generate the image data of the reference image frame. Next, the adder (110) sends the reference image data to the reference image memory (107) and the reference image memory (107) stores the reference image data. The stored reference image data is used for the predicted image generation processing of the predicted image generation unit (102) as necessary.

When the switch open signal is sent from the reference frame update determination processing unit (105), the switch unit (108) opens the switch to prevent the encoded image data from being sent to the decoding processing unit (106). Therefore, no processing is performed thereafter.

In the description of the moving image encoding apparatus 100 in FIG. 1, the subtracter (109) sends the differential image data to the reference frame update determination processing unit (105). The encoding processing unit (103) sends the encoded image data to the reference frame update determination processing unit (105). The variable-length encoding processing unit (104) sends the encoded stream to the reference frame update determination processing unit (105). Note that all data sent to the reference frame update determination processing unit (105) is not necessary. That is, only one type of data is used by the reference frame update determination processing unit (105) for the determination processing. Only one type of data must be input. Therefore, there is no need for providing the configuration for sending other data to the reference frame update determination processing unit (105).

The moving image encoding apparatus 100 described above can provide a moving image encoding apparatus that selects whether or not reference image data is generated and stored according to the correlation between encoding image and a reference frame.

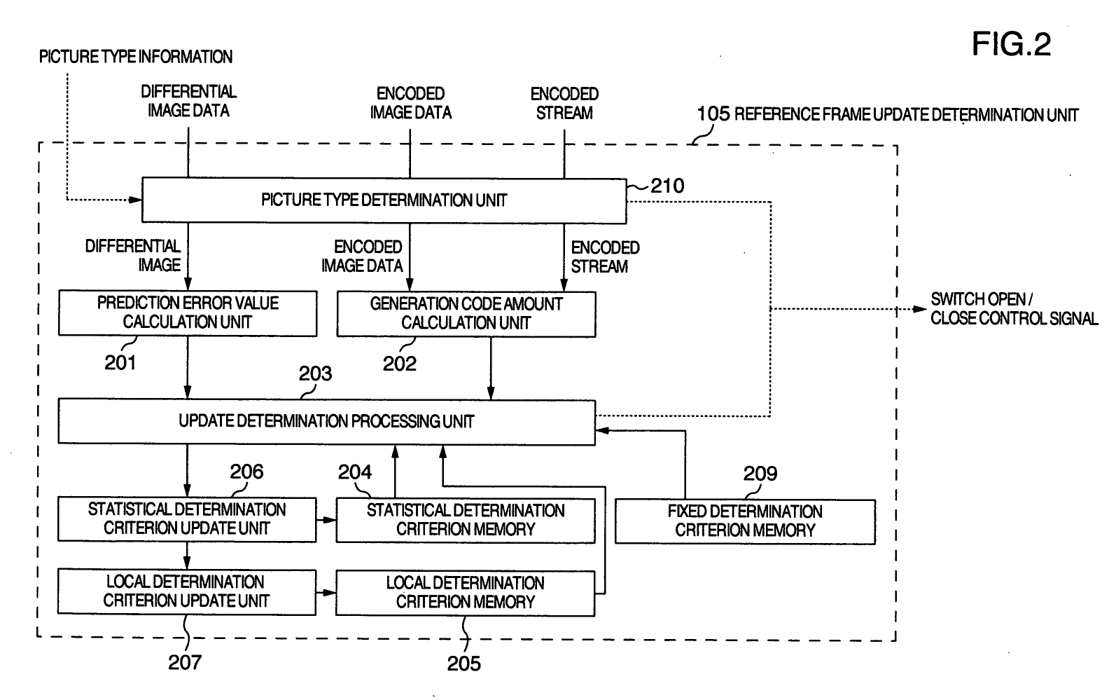

FIG. 2 shows an example of the reference frame update determination processing unit (105) in detail. The reference frame update determination processing unit (105) comprises a picture type determination unit (210) that acquires picture type information from the control unit (150) to determine the picture type of an encoding frame, a prediction error value calculation unit (201) that calculates a prediction error value included in an encoding image, a generation code amount calculation unit (202) that calculates the amount of code generated when an encoding image is encoded, an update determination processing unit (203) that determines whether or not a reference frame is updated, a fixed determination criterion memory (209) that holds predetermined fixed determination criterion information, a statistical determination criterion memory (204) that holds statistical determination criterion information associated with the correlation between a target encoding image and a reference frame, a local determination criterion memory (205) that holds local determination criterion information between frames, a statistical determination criterion update unit (206) that changes statistical determination criterion information stored in the statistical determination criterion memory (204), and a local determination criterion update unit (207) that changes local determination criterion information stored in the local determination criterion memory (205).

The picture type determination unit (210) determines the picture type of a target encoding frame input to the reference frame update determination processing unit (105) based on the picture type information acquired from the control unit (150). If the picture type of the target encoding frame is an I-picture, the picture type determination unit (210) sends the switch close signal to the switch unit (108) as the switch open/close control signal. If the picture type of the target encoding frame is a P-picture, the picture type determination unit (210) sends the differential image data to the prediction error value calculation unit (201) and sends the encoded image data or encoded stream to the generation code amount calculation unit (202). The picture type information acquired from the control unit (150) is determined by the control unit (150) from the memory address of the start point or end point of the encoded image data or the encoded stream.

Next, the prediction error value calculation unit (201) calculates the size of each component of the differential image data input from the subtracter (109) and, for each frame, calculates the total value as the prediction error value. The generation code amount calculation unit (202) calculates the amount of code generated when an encoding frame is encoded, using the encoded stream acquired from the variable-length encoding processing unit (104) or the encoding image data acquired from the encoding processing unit (103).

In addition, the update determination processing unit (203) determines the correlation between the target encoding image and the reference frame by using one of the following three types of determination criterion information: fixed determination criterion information which is predefined and is stored in the fixed determination criterion memory (209), local determination criterion information stored in the local determination criterion memory (205), and statistical determination criterion information stored in the statistical determination criterion memory (204).

The following describes a determination method that uses the fixed determination criterion information, a determination method that uses the local determination criterion information, and a determination method that uses the statistical determination criterion information. FIG. 5B will be used again in the description of those determination methods. For the sake of the description, the names Xi, Yij are set for the frame (508) to the frame (514) in FIG. 5B. The frame, whose name is Xi, is a frame that is eventually used as the reference frame in the ith update processing. The frame, whose name is Yij, is the jth frame of the frames that reference the reference frame Xi. That is, as shown in FIG. 5B, the frame (509), frame (510), and frame (511) following the reference frame X1 (508) are the first, second, and third frames that reference the reference frame X1 (508). Therefore, the their names are the frame Y11 (509), frame Y12 (510), and frame Y13 (511). The relation between the reference frame X2 (512) and the frame Y21 (513) and frame Y22 (514) is the same relation as that described above.

First, as an example of a first determination method, the following describes the determination method that uses the fixed determination criterion information. In the first determination method, the parameter of the target encoding frame Yij and predetermined data that is predefined are compared to determine if the reference frame is to be updated. For example, the following expression, expression 1, is used for the determination.
SAD(Yij)≦α or FB(Yij)≦β Expression 1
where SAD(Yij) is the prediction error sum of the target encoding frame Yij. The prediction error sum is the sum of prediction errors in the blocks in an image calculated for each frame. The prediction errors are calculated, for example, by the prediction error value calculation unit (201) in FIG. 2. FB(Yij) represents the generation code amount of the encoding frame Yij. The generation code amount is calculated, for example, by the generation code amount calculation unit (202) in FIG. 2. α and β are constants. Both are positive values.

The fixed determination criterion information used in the example of this determination method is information such as α and β. The fixed determination criterion information should be pre-set by evaluating the encoding efficiency and saved in the fixed determination criterion memory (209).

The value on the right-hand side of expression 1 is called the determination criterion value of the fixed determination criterion, and the value on the left-hand side is called the determination target calculation value.

In this determination method, satisfying expression 1 means that the correlation between the reference frame Xi and the encoding frame Yij is high. If SAD(Yij) or FB(Yij) exceeds a predetermined amount and does not satisfy expression 1, the correlation is determined to be low.

For example, when the first determination method is used, the update determination processing unit (203) of the reference frame update determination processing unit (105) shown in FIG. 2 acquires the fixed determination criterion information α or β from the fixed determination criterion memory (209) during the determination processing. At this time, the update determination processing unit (203) acquires SAD(Yij) or FB(Yij), which is the parameter for the target encoding frame, from the prediction error value calculation unit (201) or the generation code amount calculation unit (202), respectively. Therefore, the update determination processing unit (203) can perform the determination processing represented by expression 1.

If it is determined that expression 1 is not satisfied, the update determination processing unit (203) judges that the correlation between the reference frame Xi and the target encoding frame Yij is low. In this case, the update determination processing unit (203) sends the switch close signal to the switch unit (108). In response to this signal, the switch unit (108) sends the encoded image data of the encoding frame Yij, sent from the encoding processing unit (103), to the decoding processing unit (106). The encoded image data of the encoding frame Yij is added to the predicted image data of the encoding frame Yij by the adder (110). The added-up data is saved in the reference image memory (107) as new reference image data and then the reference frame update processing is completed. As a result, the target encoding frame Yij becomes a new reference frame Xk(where, k=i+1).

If it is determined that expression 1 is satisfied, the update determination processing unit (203) sends the switch open signal to the switch unit (108). In response to this signal, the switch unit (108) opens the switch to prevent the reference frame from being updated and, in this way, reduces the number of times the update processing is performed.

The determination processing, in which fixed determination criterion information is used as described above, updates the reference frame if the correlation between the encoding frame and the current reference frame is judged lower than a predetermined criterion that is predefined.

For example, in a frame where the scene is switched to a low-correlation scene or where the input image is switched from a slow-moving scene or a scene with little movement to a fast-moving scene or a scene with large movement, the value of the prediction error sum SAD(Yij) of the target encoding frame Yij or the generation code amount FB(Yij) of the encoding frame Yij becomes large. Setting α or β in advance so that expression 1 is not satisfied in such a case, the reference frame is updated. After that, if the input image is switched to a slow-moving scene or a scene with little movement, SAD(Yij) or FB(Yij) does not exceed α or β and, so, the reference frame update processing is suppressed. This reduces the amount of calculation processing involved in the update processing. In addition, the determination processing using the fixed determination criterion information limits an increase in the generation code amount, thus preventing the coding efficiency from being decreased. Therefore, the reference frame update processing using the fixed determination criterion information reduces the amount of calculation of the encoding processing while suppressing a decrease in encoding efficiency.

Next, as an example of a second determination method, the following describes the determination method that uses the local determination criterion information. In the second determination method, the parameter of the target encoding frame Yij is compared with the parameter of the frame Yil, which is the next frame of the reference frame Xi, for determining whether the reference frame is to be updated.

In one example of the determination processing using the local determination criterion information, expression 2 given below is used for the determination.
SAD(Yij)≦SAD(Yil)×y or FB(Yij)≦FB(Yil)×δ Expression 2
where, SAD(Yij) is the prediction error sum of the target encoding frame Yij, and SAD(Yil) is the prediction error sum of the frame Yil that is the next frame of the reference frame Xi. FB(Yij) is the generation code amount of the target encoding frame Yij, and FB(Yil) is the generation code amount of the frame Yil that is the next frame of the reference frame Xi. γ and δ are constants.

The local determination criterion information used in this embodiment is, for example, information such as SAD(Yil), FB(Yil), γ, and δ. That is, the local determination criterion information refers to the parameters other than those (SAD(Yij) and FB(Yij) in expression 2) for the encoding frame in expression 2.

The right-hand side of expression 2 is called the determination criterion value of the local determination criterion, and the left-hand side is called the determination target calculation value.

In the reference frame update determination processing unit (105) in FIG. 2, the local determination criterion information is stored in the local determination criterion memory (205). During the determination processing, the update determination processing unit (203) acquires the local determination criterion information from the local determination criterion memory (205). At this time, the update determination processing unit (203) also acquires SAD(Yij) or FB(Yij), which is the parameter of the target encoding frame, from the prediction error value calculation unit (201) or the generation code amount calculation unit (202), respectively. Therefore, the update determination processing unit (203) can perform the determination processing represented by expression 2.

If the update determination processing unit (203) determines that expression 2 is not satisfied, that is, if it is determined that the correlation between the reference frame Xi and the target encoding frame Yij does not satisfy the local determination criterion, the reference frame update processing is the same as that performed when it is determined that expression 1 is not satisfied. As a result, the data of the new reference image Xk (where k=i+1) is saved in the reference image memory (107).

When the current reference image is changed to the new reference image Xk, the prediction error sum or the generation code amount of the immediately-following target encoding frame Ykl becomes one of new local determination criterion information. Therefore, the local determination criterion update unit (207) acquires the prediction error sum or the generation code amount of the frame Ykl from the update determination processing unit (203) and stores it in the local determination criterion memory (205). The prediction error sum or the generation code amount of the frame Ykl is used in the subsequent determination processing.

If it is determined that expression 2 is satisfied, the update determination processing unit (203) performs the same processing as when it is determined that expression 1 is satisfied. In this case, the reference frame is not updated and, so, the number of times the update processing is performed can be reduced.

When the determination processing using the local determination criterion information as described above is used, the reference frame is updated if the correlation between the encoding frame and the current reference frame gets worse than the correlation between the current reference frame and the frame immediately after the reference frame.

For example, when the reference frame updating is suppressed in a scene where the input image is a slow-moving image, the correlation becomes lower as the target encoding frame and the current reference frame become temporally distant. That is, the value of the prediction error sum SAD(Yij) of the target encoding frame Yij or the value of the generation code amount FB(Yij) of the target encoding frame Yij gradually gets larger. This determination method can determine whether or not the reference frame should be updated based on the parameter of the frame Yil that is the next frame of the reference frame Xi.

As long as the correlation satisfies the local determination criterion based on the next frame of the reference frame, the update processing of the reference frame is suppressed. The reference frame is updated when the correlation does not satisfy the local determination criterion. Therefore, the reference frame update determination processing using the local determination criterion information can reduce the calculation processing amount of the encoding processing while suppressing a decrease in encoding efficiency.

Unlike the first determination method, the second determination method does not use the fixed determination criterion, allowing the correlation to be determined according to the input image. For example, in the case where the effective absolute values such as the fixed determination criterion information (a or can not be easily decided in advance, the second determination method is used. That is, the relative local determination criterion is set based on the parameter of the next frame of the reference frame.

Although the parameter of the frame Yil is multiplied by a constant on the right-hand side of expression 2, this is only exemplary. Instead, a function that has the frame Yil parameter as a variable may be on the right-hand side. For example, the average value may be calculated, or the weighted-sum may be calculated, with the Yil parameter as a variable. The average, median, or most-frequent value, statistically calculated from the distribution of multiple the Yil parameter, may be used. In either case, the determination processing using expression 2 achieves the effect that the calculation processing amount of the encoding processing is reduced while suppressing a decrease in encoding efficiency.

Next, as an example of a third determination method, the following describes the determination method that uses the statistical determination criterion information. In the third determination method, the data that is compared with the parameter of the encoding frame Yij is data calculated from the parameters of multiple frames. One example of the data that is compared with the parameter of the encoding frame Yij is the parameters of the frames Yml immediately after Xm(m<i) that is a reference frame (past reference frame) temporally preceding the reference frame Xi of the encoding frame Yij. That is, in the determination processing using the statistical determination criterion information in this embodiment, the statistical function, which uses the parameters of multiple frames Yal-Ybl as variables with m varying from a to b (a≦b≦i), is used as the statistical determination criterion information.

In one example of determination processing using the statistical determination criterion information, expression 3 given below is used for the determination.
SAD(Yij)≦ S̅A̅D̅(ab)×ε or FB(Yij)≦ \overline{\overline{FB}}(ab)×ζ Expression 3
where SAD(Yij) and FB(Yij) are the same parameters of a target encoding image as those in expression 1 and expression 2. For example, S̅A̅D̅(ab) represents the average value of the prediction error sums in multiple frames Yal-Ybl. F̅B̅(ab) represents the average value of the generation code amounts in multiple frames Yal-Ybl. ε and ζ represent constants.

The statistical determination criterion information used in this embodiment is, for example, information such as S̅A̅D̅(ab), F̅B̅(ab), ε, and ζ. That is, the statistical determination criterion information refers to the parameters other than those (SAD(Yij) and FB(Yij) in expression 3) for an encoding frame in expression 3.

The right-hand side of expression 3 is called the determination criterion value of the statistical determination criterion, and the left-hand side is called the determination target calculation value.

In the reference frame update determination processing unit (105) in FIG. 2, the statistical determination criterion information is stored in the statistical determination criterion memory (204). During the determination processing, the update determination processing unit (203) acquires the statistical determination criterion information from the statistical determination criterion memory (204). At this time, the update determination processing unit (203) also acquires SAD(Yij) or FB(Yij), which is the parameter of the target encoding frame, from the prediction error value calculation unit (201) or the generation code amount calculation unit (202), respectively. Therefore, the update determination processing unit (203) can perform the determination processing represented by expression 3.

If the update determination processing unit (203) determines that expression 3 is not satisfied and that the parameter of the encoding frame Yij does not satisfy the statistical determination criterion, the reference frame update processing is the same as that performed when it is determined that expression 1 is not satisfied. As a result, the data of the new reference image Xk (where k=i+1) is saved in the reference image memory (107).

If the update determination processing unit (203) determines that expression 3 is satisfied, the processing is the same as that performed when it is determined that expression 1 is satisfied. The reference frame is not updated and, so, the number of times the update processing is performed is reduced.

The parameters of past reference images are used for the statistical determination criterion information. Thus, the parameters (for example, prediction error sum or generation code amount) of the encoding frame Ykl, which follows the new reference image Xk, are also one of the parameters used for the subsequent statistical determination criterion information. Therefore, the statistical determination criterion update unit (206) acquires the prediction error sum or the generation code amount of the frame Ykl from the update determination processing unit (203) and stores it in the statistical determination criterion memory (204). The prediction error sum or the generation code amount of the frame Ykl is used in the subsequent determination processing.

The following describes the advantages of using the statistical determination criterion information in the reference frame update determination processing.

The first determination method was described before in which the reference frame update processing is performed using the fixed determination criterion information that is predefined. However, the proper value of the fixed determination criterion information, α or β, differs according to the type of an input image. In this case, the third determination method allows the determination criterion of the reference frame update processing to be changed according to the parameters of multiple frames Yml that continue to the encoding frame. That is, the determination criterion of the reference frame update processing can be determined according to the motion of the image of an input image in the scene for a predetermined period that continues to the encoding frame. For example, when the input image is switched from a slow-moving scene to a fast-moving scene, the prediction error sum or the generation code amount in each frame after the input image is switched to the fast-moving scene becomes larger than that of the scene where the input image moves slowly. The third determination method, if used in this case, allows the determination criterion of the reference frame update processing to be defined based on the scene in which the input image moves slowly.

So, even on a device that receives an input image that cannot be predicted in advance, this method compares the amount of the motion of an input image among scenes when the input image is switched from one scene to another and, based on the comparison result, properly determines whether the reference frame should be updated.

The second determination method can also determine the determination criterion of the update processing of a reference frame according to an input image. In the second determination method, assume that, when the input image is switched from a slow-moving scene to a fast-moving scene, the reference frame is updated when the input image is switched to the fast-moving scene. After that, if the fast-moving scene appears consecutively, the correlation between the consecutive frames remains low because the input image moves fast. In this case, to reduce the generation code amount and to keep good coding efficiency, it is desirable that the reference frame be updated frequently. However, even in a case where the generation code amount is large, expression 2 is satisfied in some cases if the amount specified by the parameter of the target encoding frame is almost the same as that of the parameter of the frame Yil that is the next frame of the reference frame Xi. Because the generation code amount is large in this case, the reference frame should preferably be updated for reducing the generation code amount and for achieving better encoding efficiency. Therefore, in such a case, the second determination method and the third determination method should be combined. This combination allows the fast-moving scene of the input image to be determined based on the parameter of the slow-moving scene and, as a result, increases the number of reference frame updates and properly reduces the generation code amount.

In the third method, the fast-moving scene of an input image is determined primarily based on the parameters of a slow-moving scene to reduce the calculation processing amount of the encoding processing while suppressing a decrease in encoding efficiency. Therefore, when the frames Yal-Ybl are selected for calculating the parameters used for expression 3, only those past frames Yml(m<i) may be selected whose parameter (prediction error sum or generation code amount) is equal to or smaller than a predetermined value that is predefined. Alternatively, the multiple frames may be selected whose parameter (prediction error sum or generation code amount) is equal to or less than a predetermined value and which consecutively appear a specified number of times or more. Doing so advantageously gives the average value of the parameters of slow-moving scenes.

Although the parameter of the multiple frames Yal-Ybl is multiplied by a constant on the right-hand side of expression 3, this is only exemplary. Instead, a function that has the parameters of multiple frames Yal-Ybl as variables may be on the right-hand side. For example, the average value may be calculated, or the weighted-sum may be calculated, with the Yil parameters as variables. The average, median, or most-frequent value, statistically calculated from the distribution of multiple Yil parameters, may also be used. In either case, the determination processing using expression 3 achieves the effect that the calculation processing amount of the encoding processing is reduced while suppressing a decrease in encoding efficiency.

Three determination methods have been described. In addition to the prediction error value or the generation code amount, the following may be used for the parameter in the second determination method and the third determination method: the motion vector size, the code amount of the motion vector, the quantization error value, the ratio of intra-predicted blocks in a frame, or the prediction error value for which frequency conversion such as Hadamard transform, is performed. That is, any parameter related to the encoding efficiency or the prediction efficiency of a target encoding image may be used.

In the above description, though the parameter is the sum in a frame, a value calculated with a weight applied based on the position or the type of a block may also be used. Therefore, the parameter may be selected based on the position or the type of a block.

The three methods described above may be used singly or in combination as one determination method in this embodiment.

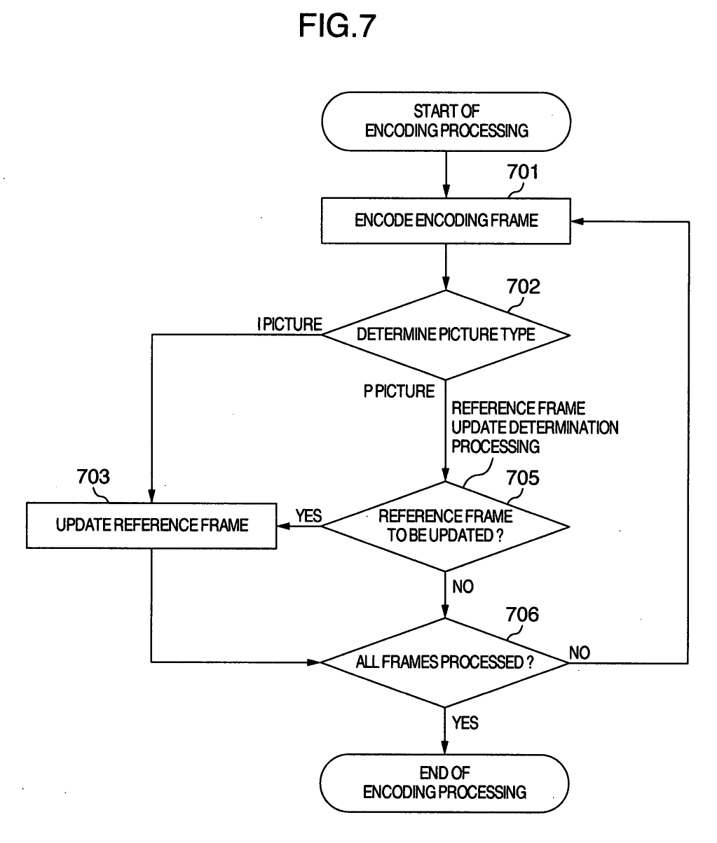

Next, FIG. 7 shows an example of the flow of the encoding processing in the first embodiment.

First, encoding processing is performed for an encoding frame (701). The processing (701) is performed by the predicted image generation unit (102), subtracter (109), encoding processing unit (103), and variable-length encoding processing unit (104) described in the operation of the moving image encoding apparatus (100) in FIG. 1. Next, the reference frame update determination processing unit (105) determines the picture type of the encoding frame (702). If the reference frame update determination processing unit (105) determines that the encoding frame is an I picture, the reference frame update determination processing unit (105) sends the switch close signal to the switch unit (108) and, in response to this signal, the switch unit (108), decoding processing unit (106), adder (110), and reference image memory (107) update the reference frame (703). After that, control is passed to the determination step (706).

On the other hand, if the encoding frame is determined to be a P picture in the determination step (702), the reference frame update determination processing unit (105) uses the determination method of this embodiment to determine if the reference frame is to be updated (705). If the reference frame update determination processing unit (105) decides that the reference frame must be updated, the reference frame is updated (703) and control is passed to the determination step (706). Conversely, if the reference frame update determination processing unit (105) decides that the reference frame need not be updated, the reference frame update determination processing unit (105) sends the switch open signal to the switch unit (108). This prevents the reference frame from being updated and passes control to the determination step (706).

In the determination step (706), a determination is made whether or not the encoding processing has been completed for all frames. This determination is made, for example, by the control unit (150). If the encoding processing is not yet completed, the encoding processing is performed for the next frame (701). On the other hand, if the encoding processing is completed, the processing is terminated.

The operation of the update determination processing unit and the moving image encoding apparatus in the first embodiment described above or the operation of the components in the flow of the encoding processing performed by them may be implemented by the autonomous operation of the components or by the instruction from the control unit (150). The control unit (150) and the software may work together to implement the operation.

The update determination processing unit and the moving image encoding apparatus in the first embodiment described above or the encoding processing performed by them controls whether or not a reference frame is to be updated. This control operation reduces the number of times the reference frame update processing is performed in a slow-moving scene and reduces the generation amount of calculation processing associated with the reference frame update processing such as the decoding processing, memory transfer processing, or other processing using decoded image data. The generation amount of calculation processing can be reduced while suppressing a decrease in encoding efficiency.

That is, the first embodiment of the present invention reduces the amount of calculation processing during the encoding processing while suppressing a decrease in encoding efficiency.

### Second Embodiment

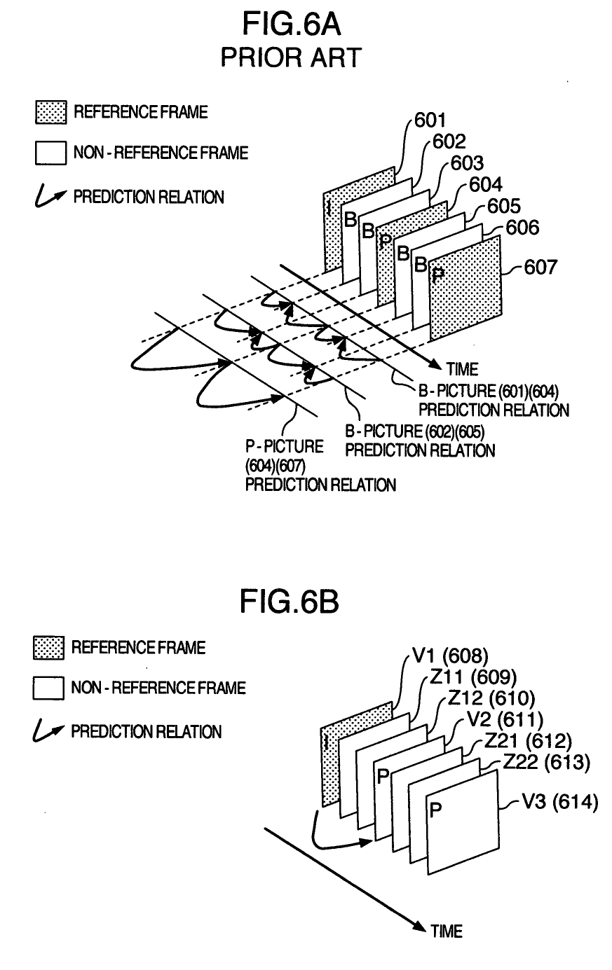

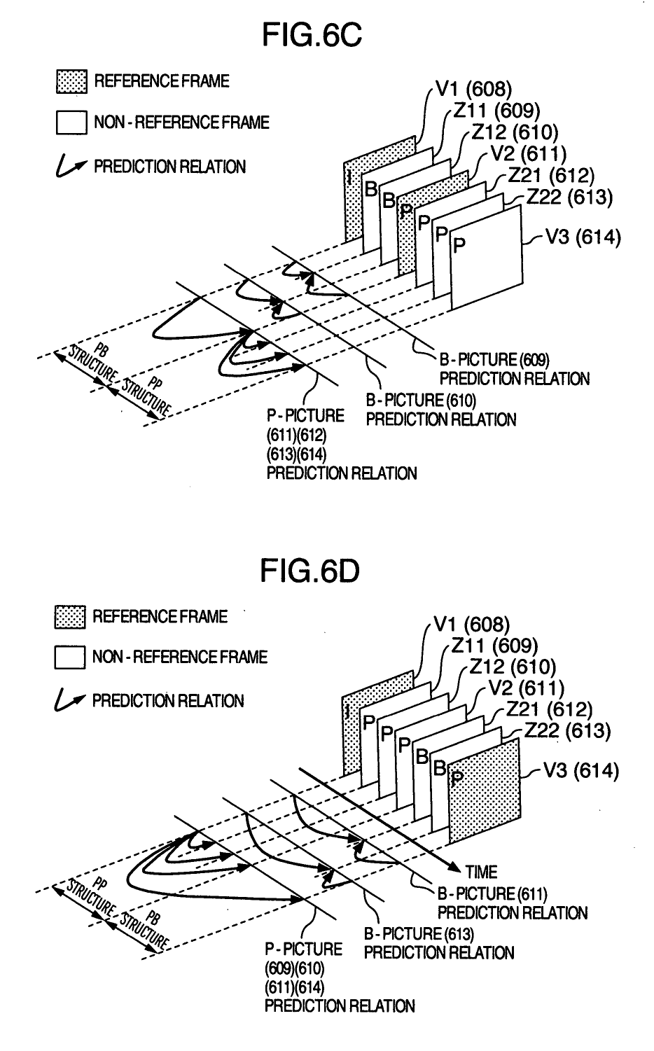

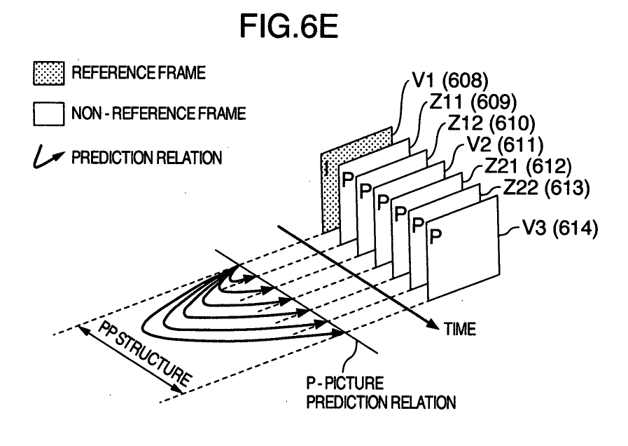

Next, the following describes a second embodiment of the present invention with reference to the drawings. FIG. 6A to FIG. 6E show multiple frames included in moving-image data. Those figures show an example of the operation of encoding processing in the prior art and an example of the operation of encoding processing in the second embodiment of the present invention. The picture type is indicated in each frame. An arrow shown in the figure indicates the prediction relation when data is encoded. An arrow indicates that a predicted image for encoding the frame at the end point of the arrow is generated with the frame at the start point of the arrow as the reference image. As shown in FIG. 5A and FIG. 5B, the picture structure used in the second embodiment of the present invention includes all of I-pictures, P-pictures, and B-pictures.

Referring to the frames (601)-(607) in FIG. 6A, the following describes the encoding processing in the prior art in which all of I-pictures, P-pictures, and B-pictures are used. First, the frame (601), the first frame, is encoded as an I-picture without referencing other frames. Next, after encoding the I frame (601), a frame that is several frames after the frame (601) is encoded as a P-picture. In this figure, the frame (604) is encoded as a P-picture. The P-picture (604) is encoded by referencing the immediately preceding I picture (601). Next, the frame (602) and frame (603), which come between the frame (601) and the frame (604), are encoded as B-pictures with the frame (601) and the frame (604) as the reference frames. Next, the frame (607), which is several frames apart from the P-picture (604), is encoded as a P-picture. The P-picture (607) is encoded with the frame (604) as the reference frame. In addition, the frame (605) and the frame (606) are encoded as B-pictures with the frame (604) and the frame (607) as the reference frames.

In this case, the reference frame must be updated after the encoding processing of all I P-pictures or P-pictures. Therefore, the update processing is performed frequently and, as a result, the processing amount of the update processing is large.

To solve this problem, the second embodiment uses not only the update processing method described in the first embodiment but also a method, which changes the picture structure according to the property of a moving image, to reduce the calculation processing amount during the encoding processing while suppressing a decrease in encoding efficiency.

The following describes this method with reference to FIGS. 6B-6E. First, the method will be described with reference to FIG. 6B. In the encoding method in this embodiment, the encoding picture structure such as the one shown in FIG. 6B is used. That is, in the picture structure shown in FIG. 6B, the frame (611) that is a P-picture with several frame pictures between itself and the I-picture (608) and the frame (614) that is a P-picture with several frames between itself and the preceding P-picture (611) are shown. Those frames are frames whose picture type is predetermined. In this embodiment, the ith frame whose picture type is predetermined is indicated as frame Vi for the sake of the description. In FIG. 6B, the frames between one V frame and the next V frame are frames whose picture type is not predetermined. In this embodiment, a frame whose picture type is not predetermined and which is arranged as the jth frame after frame Vi is indicated as frame Zij.

In the encoding method in this embodiment, the picture type of each frame Zij is determined according to the correlation between frame Vi, which temporally precedes Zij, and frame Vn(n=i+1) which temporally follows.

When frame Vn is encoded, each frame Zij is not yet encoded and, so, this frame Zij is thought of as an un-encoded frame arranged temporally between frame Vi and frame Vn at this time.

At this time, if the correlation between frame Vi and frame Vn is low, the picture type of each frame Zij is a B-picture. In this case, as in the prior-art technology shown in FIG. 6A, the frames of this data are arranged in order of the reference picture, B-picture, and the P-picture. In the description of this embodiment, data arranged in such a picture type order is represented as the expression “the picture structure is the PB structure.”

If the correlation between frame Vi and frame Vn is low, the picture type of each frame Zij is a B-picture because of the following reason. That is, when a frame between frame Vi and frame Vn is encoded, the correlation between a target encoding frame arranged between both frames and frame Vi gets lower as the encoding frame gets nearer to frame Vn. In the forward prediction encoding in which frame Vi is used as, the reference frame, a predictive image is generated based on frame Vi. So, as the target encoding frame gets nearer to frame Vn, the prediction error value and the generation code amount become large. In contrast, if bi-directional prediction encoding in which the frame Vi and the frame Vn are used as the reference frames, the predictive image can be generated by selecting one of the two types of encoding, that is, the encoding using frame Vi and frame Vn and the encoding using one of both frames, whichever is better in encoding efficiency. Thus, this method can suppress the prediction error value and the generation code amount of an encoding frame.

Next, if the correlation between frame Vi and frame Vn is high, the picture type of each frame Zij is a P-picture. In the description of this embodiment, data arranged in such a picture type order is represented as the expression “the picture structure is the PP structure.”

If the correlation between frame Vi and frame Vn is high, the picture type of each frame Zij is a P-picture because of the following reason. That is, when a frame between frame Vi and frame Vn is encoded, the correlation between a target encoding frame arranged between both frames and frame Vi remains high wherever the target encoding frame is arranged between both frames. This is because the correlation between frame Vn and frame Vi is high. In such a case, the prediction error value and the generation code amount do not change much both in the forward prediction encoding in which frame Vi is the reference frame and in the bi-directional prediction encoding in which frame Vi and frame Vn are the reference frames. Therefore, in such a case, the forward prediction encoding, rather than the bi-directional prediction encoding, can suppress the generation of reference frame update processing in which frame Vn is the reference frame.

The determination described above reduces the calculation processing amount during the encoding processing while suppressing a decreased in encoding efficiency.

The following describes this determination method more in detail with reference to FIG. 6C to FIG. 6E. FIG. 6C to FIG. 6E show an example of multiple frames included in moving image data, the arrows indicating an example of the prediction relation during the encoding time, the picture types of the frames, and the picture structures each composed of a part of frames.

First, FIG. 6C shows that the correlation between the frame V1 (608), which is an I-picture, and the frame V2 (611), which is a P-picture, is low and that the correlation between the frame V2 (611), which is a P-picture, and the frame V3 (614), which is a P-picture, is high.

First, the frame V1 (608), the first frame, is encoded as an I-picture without referencing other frames. The frame V1 (608) is saved in the memory as reference image data. Next, the frame V2 (611), which is several frames apart from the frame V1 (608), is encoded as a P-picture with the frame V1 (608) as the reference frame. At this time, the correlation between the frame V2 (611) and the frame V1 (608) is also determined. In the case of FIG. 6C, the correlation between the frame V2 (611) and the reference frame V1 (608) is low. This correlation corresponds to a case in which the correlation is determined to be low and, so, the reference frame update processing is performed in which the frame V2 (611) is stored in the memory as a new reference frame. In addition, the frame Z11 (609) and the frame Z12 (610) are determined to be B-pictures. The frame Z11 (609) and the frame Z12 (610) are encoded with the frame V1 (608) and the frame V2 (611) as the reference frame. In the encoding processing shown in FIG. 6C, the picture structure from the frame Z11 (609) to the frame V2 (611) is the PB structure as shown in the figure.

Next, the next P-picture V3 (614) is encoded using the new reference frame V2 (611). At this time, the correlation between the P-picture V3 (614) and the reference frame V2 (611) is determined. In the example shown in FIG. 6C, the correlation between the frame V3 (614) and the reference frame V2 (611) is high. This correlation corresponds to a case in which the correlation is determined to be high. In this case, the frame V3 (614) is not used as the new reference frame but the encoded result of the frame V3 (614) is once saved in the memory. Next, the picture type of the frame Z21 (612) and the frame Z22 (613) is determined to be a P-picture, and they are encoded by referencing the current reference frame V2 (611). When the encoding of the frame Z21 (612) and the frame Z22 (613) is completed, the encoded result of the frame (614) that has been saved is called from the memory. The processing described above completes the encoding from the frame (608) to the frame (614). In the encoding processing in FIG. 6C, the picture structure from the frame Z21 (612) to the frame V3 (614) is the PP structure as shown in the figure.

Thus, when the correlation between the P-picture frame V3 (614) and the reference frame V2 (611) in FIG. 6C is determined, the picture structure of the encoding data is also decided to be changed from the PB structure to the PP structure.

Next, FIG. 6D shows that the correlation between the frame V1 (608), which is an I-picture, and the frame V2 (611), which is a P-picture, is high and that the correlation between the frame V2 (611), which is a P-picture, and the frame V3 (614), which is a P-picture, is low.

First, the frame V1 (608) is encoded as an I-picture without referencing other frames. After that, the frame V2 (611) is encoded as a P-picture by referencing the frame V1 (608). At this time, the correlation between the frame V1 (608) and the frame V2 (611) is determined in the same way as in the example in FIG. 6C. Using the determination result, whether or not the reference frame should be updated is determined. In addition, the picture structure is determined, and the picture type of the frame Z11 (609) and the frame Z12 (610) is determined. In the example in FIG. 6D, the correlation between the frame V1 (608) and the frame V2 (611) is high. In this case, the correlation corresponds to a case in which the correlation is determined to be high. So, the frames from the frame Z11 (609) to the frame V2 (611) in FIG. 6D are encoded in the same manner as the frames from the frame Z21 (612) to the frame V3 (614) in FIG. 6C. That is, when the determined is made at the time the frame V2 (611) is encoded, the reference frame is not updated. The picture structure from the frame Z11 (609) to the frame V2 (611) is the PP structure, and both the frame Z11 (609) and the frame Z12 (610) are encoded as a P-picture that references the frame V1 (608).

Next, because the reference image is still the frame V1 (608), the frame V3 (614), which is a P-picture, is encoded by referencing the frame V1 (608). At this time, the correlation between the frame V1 (608), which is the current reference frame, and the frame V3 (614), which is the current target encoding image, is determined. In the example shown in FIG. 6D, the correlation between the frame V1 (608) and the frame V2 (611) is high and the correlation between the frame V2 (611) and the frame V3 (614) is low. Therefore, the correlation between the frame V1 (608) and the frame V3 (614) is low. In this case, the correlation corresponds to a case in which the correlation is determined to be low, and the reference frame update processing is performed in which the frame V3 (614) is stored in the memory as a new reference frame. The picture structure from the frame Z21 (612) to the frame V3 (614) is the PB structure, and both the frame Z21 (612) and the frame Z22 (613) are encoded as B-pictures that reference the frame V1 (608) and the frame V3 (614).

When an encoded stream is generated using an example of the encoding method shown in FIG. 6D described above, that is, when a predetermined reference frame (for example, frame (608) in FIG. 6D) which is used by other frames for forward prediction and multiple P-picture frames (for example, frame (609), frame (610), and frame (611) in FIG. 6D) which are not the reference frame of other pictures consecutively appear temporally as shown in FIG. 6D, the multiple P-picture frames are all encoded by referencing the predetermined reference frame (for example, frame (608) in FIG. 6D).

At this time, if the multiple P-picture frames (for example, frame (609), frame (610), and frame (611) in FIG. 6D) are followed temporally and immediately by one or more B-picture frames (for example, frame (612) and frame (613) in FIG. 6D), a characteristic encoded stream is generated in which all of the one or more B-picture frames include the predetermined reference frame (for example, frame (608) in FIG. 6D) as at least one of the reference frames.

At this time, if the one or more B-picture frames are followed immediately by a P-picture frame (for example, frame (614) in FIG. 6D), a characteristic encoded stream is generated in which the P-picture frame references the predetermined reference frame (for example, frame (608) in FIG. 6D).

Next, FIG. 6E shows that the correlation between the frame V1 (608), which is an I-picture, and the frame V2 (611), which is a P-picture, is high and that the correlation between the frame V2 (611), which is a P-picture, and the frame V3 (614), which is a P-picture, is also high.

First, the frame V1 (608) is encoded as an I-picture without referencing other frames. After that, the frame V2 (611) is encoded as a P-picture by referencing the frame V1 (608). The correlation between the frame V1 (608) and the frame V2 (611) is high in the same way as in FIG. 6D. Therefore, the encoding processing for the frame V2 (611), frame Z11 (609), and frame Z12 (610) is the same as that in FIG. 6D.

Next, when the P-picture frame V3 (614) is encoded, the reference image is still the frame V1 (608) as it is in FIG. 6D. Therefore, the frame V3 (614), which is a P-picture, is encoded by referencing the frame V1 (608). At this time, there is a need for determining the correlation between the frame V1 (608) and the encoding frame V3 (614), but FIG. 6E shows that the correlation between the reference frame V1 (608) and the frame V2 (611) is high and the correlation between the frame V2 (611) and the frame V3 (614) is also high. This means that the correlation between the reference frame V1 (608) and the encoding frame V3 (614) is also high. Therefore, the reference frame is not updated either in this case. Next, the picture structure from the frame Z21 (612) to the frame V3 (614) is the PP structure, and both the frame Z21 (612) and the frame Z22 (613) are encoded as P-pictures that reference the frame V1 (608).

As a result, in the example in FIG. 6E, all frames that follow the frame V1 (608), which is the first frame that is an I picture, are P-pictures that reference the frame V1 (608).

An example of the encoding processing method in this embodiment has been described for multiple cases, in which the predetermined frames of moving image data are configured in different correlations, with reference to FIG. 6B to FIG. 6E. The processing described above reduces the reference frame update processing and, so, reduces the amount of processing required for encoding. For example, in the prior-art encoding processing shown in FIG. 6A, the reference frame update processing is performed twice, once after the encoding processing of the frame (603) and once when the frame (607) is encoded. In contrast, in the encoding processing in FIG. 6C, the reference frame update processing is performed only once when the frame V2 (611) is encoded. In the example in FIG. 6D, the reference frame update processing is performed once when the frame V3 (614) is encoded. In the example in FIG. 6E, the reference image is the original frame V1 (608) throughout the processing and no reference frame update processing is performed.

Therefore, with a frame, which is several frames after the reference frame, as a P-picture, the method described above determines the correlation between this P-picture and the reference frame to determine if the reference frame is to be updated and, thereby, reduces the number of times the update processing is performed.

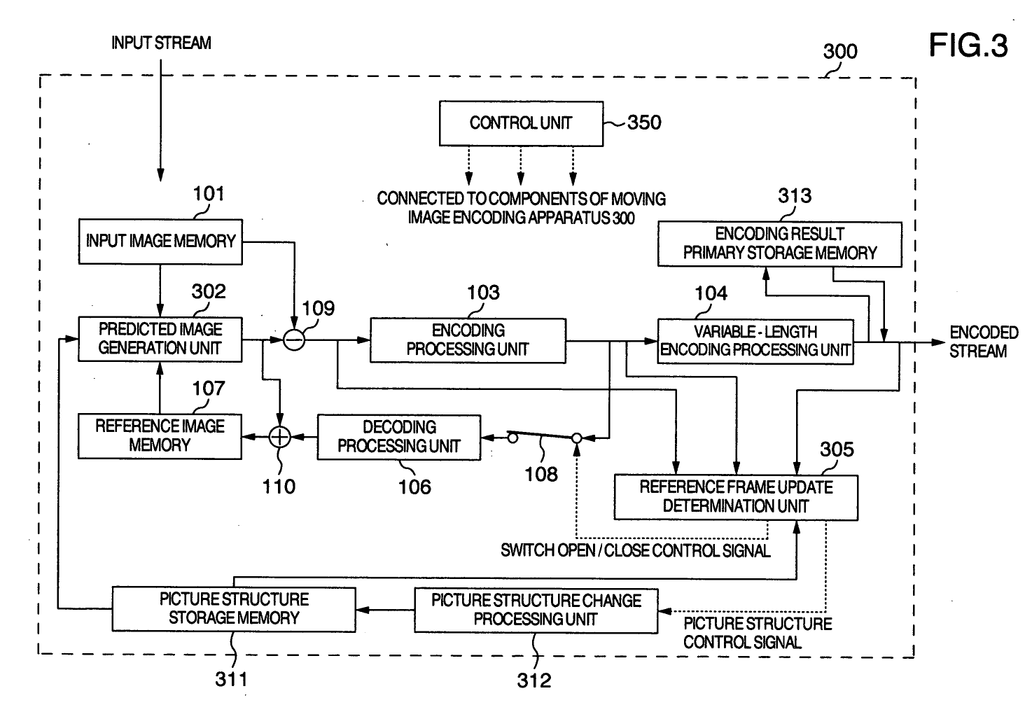

Next, the following describes an example of a moving image encoding apparatus in this embodiment with reference to FIG. 3. In the configuration shown in FIG. 1, the picture structure composed of picture types, such as I-pictures, P-pictures, and B-pictures, is used for encoding.

A moving image encoding apparatus (300) in FIG. 3 is the moving image encoding apparatus 100 in the first embodiment to which the components are added to process the picture structure including B-pictures. A component of the moving image encoding apparatus (300) in FIG. 3 with the same reference numeral as that of a component of the moving image encoding apparatus 100 in FIG. 1 has the same function. The further description of that component will be omitted. The following describes only the new components of the moving image encoding apparatus (300) in FIG. 3.

That is, the moving image encoding apparatus (300) shown in FIG. 3 is the moving image encoding apparatus (100) in the first embodiment to which a picture structure storage memory (311) that stores the current picture structure, a picture structure change processing unit (312) that changes the picture structure, and an encoding result primary storage memory (313) that temporarily stores the encoding result of one P-picture are newly added. To provide compatibility with those new components, a reference frame update determination processing unit (305) has a structure different from that in the first embodiment. In addition, a predicted image generation unit (302) is connected to the picture structure storage memory (311) to perform the operation that partially differs from that in the first embodiment.

The picture structure storage memory (311) holds information on the current picture structure (for example, whether the structure is a PB structure or a PP structure). When this information is updated or the transmission of this information is requested, the information is sent to the predicted image generation unit (302) and the reference frame update determination processing unit (305). The predicted image generation unit (302) encodes an encoding image based on the notified picture structure information.

The reference frame update determination unit (305) has not only the function of the reference frame update determination unit (105) in FIG. 1 but also a new function to determine if the current picture structure must be changed to another picture structure using the determination result indicating if the reference frame must be updated. If it is judged that the picture structure must be changed, the reference frame update determination unit (305) sends the picture structure control signal to the picture structure change processing unit (312). Based on the received signal, the picture structure change processing unit (312) changes the content of the current picture structure information, which is held in the picture structure storage memory (311), to one of the PP structure information or the PB structure information.

If it is necessary to hold the stream information, corresponding to the encoding frame, temporarily in the memory as a result of the change in the picture structure, the information is held in the encoding result primary storage memory (313). After that, when the part of the encoded stream that is held is combined with the output encoded stream for output, the part is output from the encoding result primary storage memory (313) and is combined with the current output encoded stream for output.

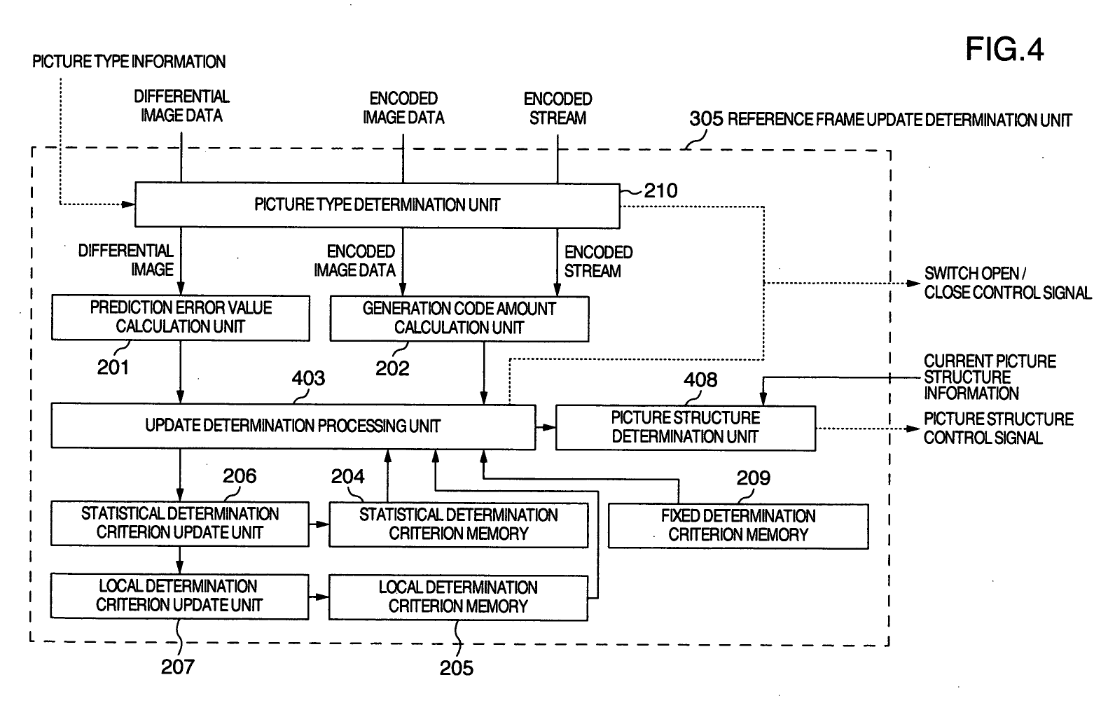

Next, the following describes an example of the structure of the reference frame update determination processing unit (305) with reference to FIG. 4. The reference frame update determination processing unit (305) shown in FIG. 4 has the structure in which a picture structure determination unit (408) is added to the reference frame update determination processing unit (105) in the first embodiment. The picture structure determination unit (408) acquires the determination result of an update determination processing unit (403) and, based on this determination result, determines if the picture structure is to be changed. Based on the result of determination if the picture structure is to be changed, the picture structure determination unit (408) sends the picture structure control signal to the picture structure change processing unit (312).

The update determination processing unit (403) in the second embodiment also determines the correlation between the target encoding image and the reference frame using the fixed determination criterion information, local determination criterion information, and statistical determination criterion information in the same way as in the first embodiment.

Note that, in the second embodiment, the update determination processing unit (403) performs the reference frame update determination processing only when the current target encoding frame is a frame V in FIG. 6B to FIG. 6E. Therefore, the update determination processing unit (403) does not process a frame Z during the reference frame update determination processing. If the current target encoding frame is a frame Z in FIG. 6B to FIG. 6E, the update determination processing unit (403) sends the switch open signal to the switch unit (108) as the switch open/close signal. Sending this signal suppresses the reference frame update processing when the target encoding frame is a frame Z in FIG. 6B to FIG. 6E.

If the current target encoding frame is a frame V in FIG. 6B to FIG. 6E, the determination processing is performed as follows. That is, the operation of the update determination processing unit (403) in the second embodiment can be implemented by replacing the description of the update determination processing unit (203), the description of the fixed determination criterion information, the description of the local determination criterion information, and the description of the statistical determination criterion information in the first embodiment as follows.

First, a frame in the description in FIG. 5B in the first embodiment is replaced by a frame V in FIG. 6B to FIG. 6E in the second embodiment. First, the frame Vs(sth frame V), which is a frame V in FIG. 6B to FIG. 6E and is a reference frame, is replaced by Xi in the description of the first embodiment. The frame Vt(t=s+1) that is the next frame of the reference frame Vs is frame Yil that is the next frame of Xi in the description of the first embodiment. Similarly, the frame V that is the jth frame from the reference frame Vs is replaced by the frame Yij in the description of the first embodiment. That is, the arrangement of the frame V in the second embodiment (for example, V1, V2, V3, V4, V5, V6, . . . ) is replaced by the arrangement of frames in the first embodiment (for example, X1, Y11, Y12, X2, Y21, and Y22), and the description of the first embodiment and expression 1, expression 2, and expression 3 are applied.

Thus, if the current target encoding image is a frame V in FIGS. 6B to 6E, the update determination processing unit (203) in the second embodiment performs the determination processing, corresponding to each frame in the description in FIG. 5B in the first embodiment, to reduce the calculation processing amount during the encoding processing while suppressing a decrease in encoding efficiency.

If the determination result of the update determination processing unit (403) is that the correlation between the target encoding image and the reference image is high, the picture structure determination unit (408) issues the picture structure control signal, which changes the picture structure to the PP structure, to the picture structure change processing unit (312) in FIG. 3. If the determination result of the update determination processing unit (403) is that the correlation between the target encoding image and the reference image is low, the picture structure determination unit (408) issues the picture structure control signal, which changes the picture structure to the PB structure, to the picture structure change processing unit (312) in FIG. 3.

It is also possible that the picture structure determination unit (408) is made independent of the reference frame update determination processing unit (305) and, in addition, the picture structure determination unit (408), picture structure change processing unit (312), and picture structure storage memory (311) are integrated into one prediction-direction determination unit. This is because, if a frame V is the current target encoding image, deciding the picture structure is equivalent to deciding the picture type of a frame Z that is temporally between the target encoding image and the reference frame. In other words, this is equivalent to deciding the prediction method, forward prediction or bi-directional prediction, of a predicted image used in the encoding processing of the frame Z.

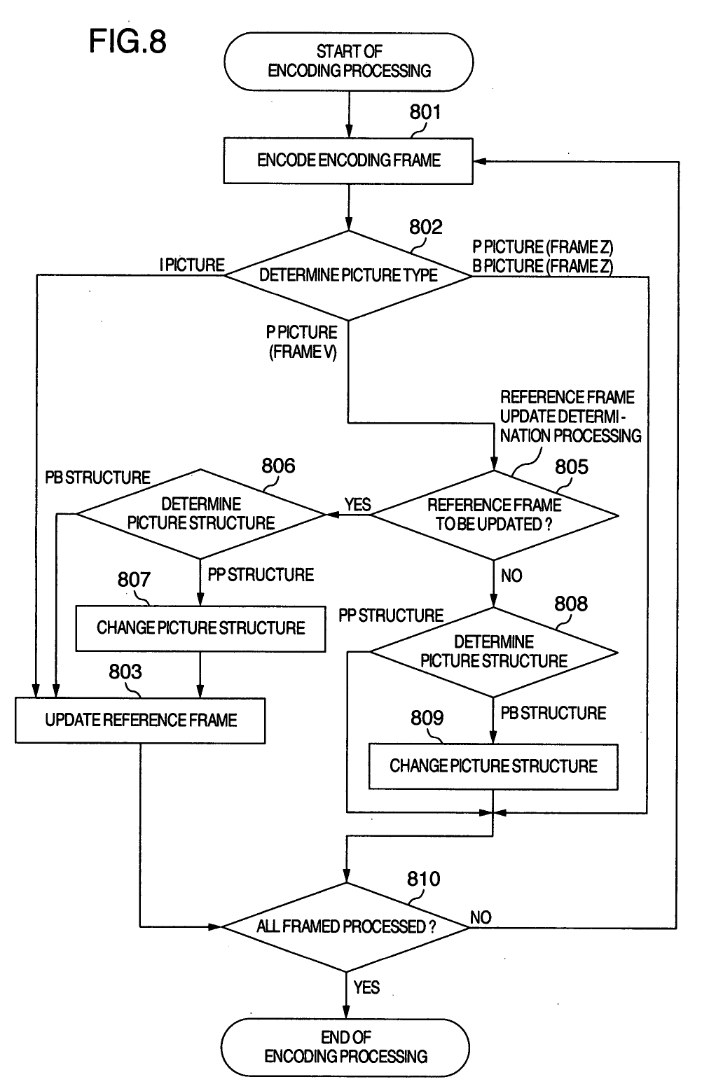

Next, FIG. 8 shows an example of the flow of encoding processing in the second embodiment. In FIG. 8, a P-picture must be distinguished between the P-picture of a frame V and the P-picture of a frame Z. To distinguish between them, they are denoted as “P-picture (frame V)” and “P-picture (frame Z)”, respectively.

First, one target encoding frame is encoded (801). This processing (801) is performed by the operation of the predicted image generation unit (302), subtracter (109), encoding processing unit (103), and variable-length encoding unit (104) included in the moving image encoding apparatus (300) in FIG. 3. Next, the reference frame update determination processing unit (305) determines the picture type of the target encoding frame (802). If the encoding frame is an I-picture, the reference frame update determination processing unit (305) sends the switch close signal to the switch unit (108). Next, in response to this signal, the switch unit (108), decoding processing unit (106), adder (110), and reference image memory (107) update the reference frame (803). After that, in the determination step (810), the determination is made if all frames are encoded. This determination (810) is made, for example, by a control unit (350). If all frames are not yet encoded, control is passed back to the encoding step (801). If all frames are encoded, the encoding processing is terminated.

On the other hand, if it is determined in the update determination step (802) that the encoding frame is the P-picture of a V frame, the update determination processing unit (305) uses the determination method in this embodiment described above to determine if the reference frame must be updated (805).

If it is determined by the update determination processing unit (305) in the determination step (805) that the reference frame must be updated, control is passed to the determination step (806). In the determination step (806), the picture structure determination unit (408) determines if the picture structure is the PP structure or the PB structure. If the picture structure is the PP structure, the picture structure is changed (807). This processing is performed as follows. That is, the picture structure determination unit (408) sends the picture structure control signal, which changes the picture structure from the PP structure to the PB structure, to the picture structure change processing unit (312). Next, the picture structure change processing unit (312) changes the current picture structure information, held in the picture structure storage memory (311), from the PP structure information to the PB structure information. The above steps complete the picture structure change processing (807). Next, control is passed to the reference frame update processing (803). If it is determined in the determination step (806) that the picture structure is the PB structure, the picture structure is not changed but control is passed to the reference frame update processing (803). That is, if the reference frame must be updated after the frame V is encoded as a P-picture (if the correlation between the reference frame and the encoding frame is low), the picture structure is set to the PB structure regardless of the current picture structure. After that, the reference frame is updated (803) and control is passed to the determination step (810). If it is determined in the determination step (810) that all frames are not yet encoded, control is passed back to the encoding processing (801). If all frames are encoded, the encoding processing is terminated.

If, in the determination step (805), it is determined by the update determination processing unit (305) that the reference frame need not be updated (805), control is passed to the determination step (808). In the determination step (808), the picture structure determination unit (408) determines whether the picture structure is the PP structure or the PB structure. If the picture structure is the PB structure, the picture structure is changed (809). This processing is performed as follows. That is, the picture structure determination unit (408) sends the picture structure control signal, which changes the picture structure from the PB structure to the PP structure, to the picture structure change processing unit (312). Next, the picture structure change processing unit (312) changes the current picture structure information, held in the picture structure storage memory (311), from the PB structure information to the PP structure information. The above steps complete the picture structure change processing (809). Next, control is passed to the determination step (810). If it is determined in the determination step (808) that the picture structure is the PP structure, the picture structure is not changed but control is passed to the determination processing (810). That is, if the reference frame need not be updated after the frame V is encoded as a P-picture (if the correlation between the reference frame and the encoding frame is high), the picture structure is set to the PP structure regardless of the current picture structure. If it is determined in the determination step (810) that all frames are not yet encoded, control is passed back to the encoding processing (801). If all frames are encoded, the encoding processing is terminated.

If the encoding frame is the P-picture of a frame Z or the B-picture of a frame Z in the determination step (802), control is passed to the determination step (810). If it is determined in the determination step (810) that all frames are not yet encoded, control is passed back to the encoding processing (801). If all frames are encoded, the encoding processing is terminated.

An encoded stream for which the encoding processing (801) is performed is output as necessary. In this case, depending upon the picture structure, a part of the encoded stream is held temporarily in the encoding result primary storage memory (313). By doing so, the encoded stream is output with its output time or output order adjusted.

The operation of the update determination processing unit and the moving image encoding apparatus in the second embodiment described above or the operation of the components in the flow of the encoding processing performed by them may be implemented by the autonomous operation of the components or by the instruction from the control unit (350). The control unit (350) and the software may work together to implement the operation.

The update determination processing unit and the moving image encoding apparatus in the second embodiment described above or the encoding processing performed by them controls whether or not a reference frame is to be updated also in the moving image encoding processing in which B-pictures are used. This control operation reduces the number of times the reference frame update processing is performed, for example, in a slow-moving scene and reduces the generation amount of calculation processing associated with the reference frame update processing such as the decoding processing, memory transfer processing, or other processing using decoded image data. In addition, controlling the number of reference frame update processing operations and changing a part of the picture structure of encoded data reduce the calculation processing generation amount and, at the same time, suppresses a decrease in encoding efficiency.

That is, the second embodiment of the present invention reduces the amount of calculation processing during the encoding processing while suppressing a decrease in encoding efficiency.

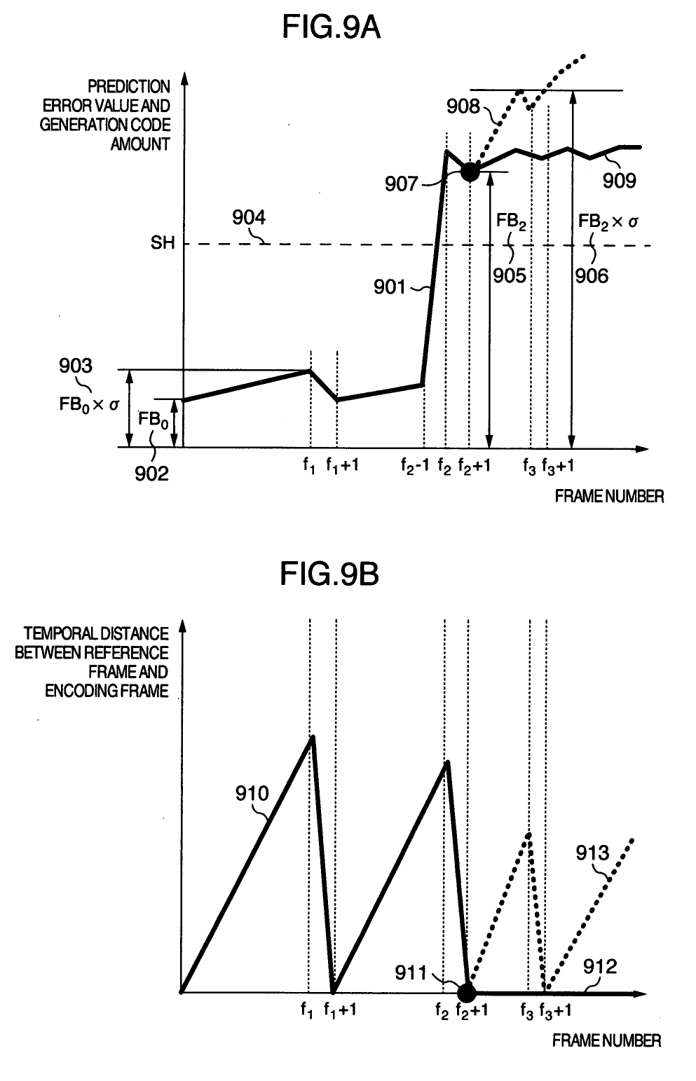

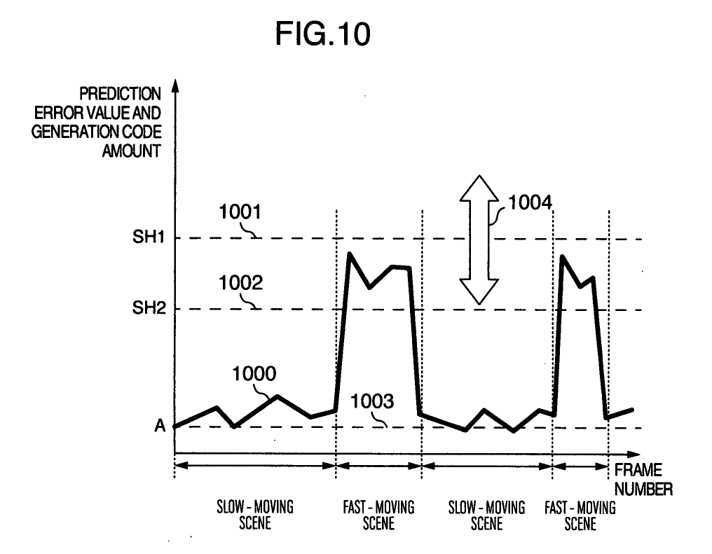

Next, an example of the encoding processing in the first embodiment and the second embodiment described above will be described with reference to FIG. 9A, FIG. 9B, and FIG. 10.

First, the following describes an example of the encoding processing in the first embodiment with reference to FIG. 9A. The horizontal axis in FIG. 9A indicates the time or the frame number. The vertical axis indicates the prediction error amount or the generation code amount per frame. The value on the vertical axis may be other parameters described in the reference frame update processing. The larger the value on the vertical axis, the larger the difference in the image between the reference frame and the encoding frame. Therefore, the value is high in a scene where the image motion from one frame to the next in a moving image is large. Conversely, the value is low in a scene where the image motion from one frame to the next in a moving image is small. Because an I-picture frame is encoded using intra-frame prediction, the difference between frames has no meaning. Therefore, in this figure, the prediction error amount or the generation code amount of an I-picture frame is omitted from the graph.

In the description of FIG. 9A below, the horizontal axis indicates the frame number and the vertical axis indicates the generation code amount for the sake of the description. The graph in FIG. 9A begins with the generation code amount FB₀(902) of the frame following the initial reference frame. In the data (901) in FIG. 9A, the relatively slow moving scenes continue to frame f₂−1. Next, the fast-moving scene suddenly starts in frame f₂ and, after that, fast-moving scenes continue.

The following describes an example of reference frame update determination processing performed by the reference frame update determination processing unit (105) in the first embodiment using the local determination criterion information and the fixed determination criterion information. Assume that expression 2 is used for the local determination criterion in this figure. That is, the reference frame update processing is performed using the threshold calculated by multiplying the generation code amount of the frame following the initial reference frame by the constant σ. The threshold of the fixed determination criterion is the generation code amount SH(904). This generation code amount SH(904) corresponds to β in expression 1.

First, when the encoding is started, FB₀×σ (903) becomes the local determination criterion threshold based on the generation code amount FB₀(902). If the code amount of the target encoding frame is lower than the local determination criterion, the reference frame is not updated. In this figure, the code amount reaches the local determination criterion threshold FB₀×σ (903) of the encoding frame at the frame number f1. At this time, the reference frame update determination processing unit (105) performs the determination processing and, as a result, the reference frame is updated. After the reference frame is updated, the correlation between the reference frame and the encoding frame becomes high. So, at frame f₁+1 that is the next frame of the new reference frame, the generation code amount decreases to the level of frame f₁. This means that, in the first embodiment, the determination based on the local determination criterion in a slow-moving scene reduces the number of times the reference frame update processing is performed and reduces the calculation processing amount during the encoding processing while suppressing a decrease in encoding efficiency.

Next, the data (901) suddenly moves fast at frame f₂ and the generation code amount is increased. First, the following describes the processing that is performed assuming that the reference frame update determination processing unit (105) does not use the fixed determination criterion in this figure. In this case, because the generation code amount of frame f₂ exceeds the local determination criterion threshold FB₀×σ (903), the reference frame is updated. The frame f₂ becomes the new reference frame. Therefore, the new local determination criterion threshold FB₂×σ (906) is determined from the generation code amount FB₂ (905) of the frame f₂+1 that is the next frame of frame f₂. In this case, the generation code amount data increases like the data (908) indicated by the dotted line starting at the point (907).

Next, the following describes a case in which the reference frame update determination processing unit (105) sets the threshold SH(904) as the fixed determination criterion in this figure. In this case, the generation code amount of frame f₂ exceeds not only the local determination criterion threshold FB₀×σ (903) but also the fixed determination criterion threshold SH(904), the reference frame is updated. Next, because the generation code amount of FB₂(905) of frame f₂+1 is smaller than the new local determination criterion threshold FB₂×σ (906) but is larger than the fixed determination criterion threshold SH(904), the reference frame is updated in this case, too. After that, the reference frame is updated for each frame until the generation code amount of the encoding frame falls below the fixed determination criterion threshold SH(904). Therefore, when the fixed determination criterion is used, the generation code amount after the point (907) in this figure gets smaller than the data (908) described above, and the generation code amount changes like the data (909) indicated by the solid line. Therefore, in the first embodiment, the determination based on the fixed determination criterion in a fast-moving scene controls the number of times the reference frame update processing is performed, suppresses a decrease in encoding efficiency, and reduces the calculation processing amount during the encoding processing.

Next, FIG. 9B shows an example of the relation between the reference frame and the encoding frame in the first embodiment in FIG. 9A. The horizontal axis in FIG. 9B indicates the frame number in the same way as it does in FIG. 9A. The vertical axis in FIG. 9B indicates the temporal distance between the reference frame and the encoding frame. The temporal distance value of 0 indicates that the reference frame is the frame immediately before the encoding frame. A larger distance value indicates that the reference frame is temporally more distant from the encoding frame into the past direction. In the first embodiment in FIG. 9B, the reference frame is updated at frame f₁ and frame f₂. So, the temporal distance between the reference frame and the encoding frame changes as indicated by the data (910). That is, the temporal distance increases until the reference frame is updated and, when the reference frame is updated, the temporal distance is set to 0. Next, if only the local determination criterion described above is used after the point (911), the temporal distance changes as indicated by the data (913) indicated by the dotted line. If both the local determination criterion and the fixed determination criterion described above are used, the temporal distance changes as indicated by the data (912) indicated by the solid line.

Referring to FIG. 10, the following describes an example of encoding processing that is performed when the reference frame update determination processing unit (105) in the first embodiment uses the statistical determination criterion information. In FIG. 10, the data (1000) shows an example of generation code amount data. SH₁(1001) indicates the fixed determination criterion threshold. SH₂(1002) indicates an example of the statistical determination criterion threshold. The fixed determination criterion threshold SH₁(1001) in the first embodiment is stored in advance in the fixed determination criterion memory (209) as the fixed determination criterion information. The SH₁(1001) is set, for example, by evaluating the statistical data in advance or by considering other conditions. However, it is possible that a proper fixed determination criterion threshold SH₁(1001) cannot be set, for example, when data other than assumed moving image data is encoded or when there is not enough statistical data for setting the fixed determination criterion information. For example, like the generation code amount data (1000) shown in the figure, it is possible that neither a fast-moving scene nor a slow-moving scene exceeds the fixed determination criterion threshold SH₁(1001). In such a case, the determination method using the fixed determination criterion information is not efficient. To solve this, the threshold SH₁(1001) is changed to the statistical determination criterion threshold described in the first embodiment so that the threshold itself varies according to the statistical data as indicated by the arrow (1004) in the figure. At this time, if the actual generation code amount is smaller than the pre-assumed moving image generation code amount, the threshold is decreased by using the statistical data described in the first embodiment. For example, assume that the threshold is decreased to SH₂(1002) shown in the figure. Then, for the data (1000) in FIG. 10, the reference frame is updated for each frame if the scene a fast-moving scene. This method gives the same effect as that given by the fixed determination criterion threshold SH in FIG. 9A.

In a slow-moving scene, the number of times the reference frame update processing is reduced in the same way as in FIG. 9A. Therefore, in the first embodiment, the determination based on the statistical determination criterion suppresses a decrease in encoding efficiency and, at the same time, reduces the number of times the reference frame update processing is performed and, thereby, reduces the calculation processing amount during the encoding processing even in a case in which an input image that is not pre-assumed is received.

Next, an example of the encoding processing in the second embodiment will be described also with reference to FIGS. 9A and 9B and FIG. 10. In the description of the second embodiment, it is assumed that not only the prediction error amount or the generation code amount of I-picture frames but also that of frames Z in the description of FIG. 6 is omitted from the graph in FIG. 9A. In this case, the horizontal axis in FIG. 9A corresponds to the frames V in FIG. 6 from which the I-picture frames are removed. The same effect as that in the first embodiment can be also obtained in the second embodiment by performing the same replacement in the description of the first embodiment shown in FIG. 9B and FIG. 10.

That is, also in the encoding processing in the second embodiment, the determination based on the local determination criterion in a slow-moving scene reduces the number of times the reference frame is updated and reduces the calculation processing amount during the encoding processing while suppressing a decrease in encoding efficiency.

Also in the encoding processing in the second embodiment, the determination based on the fixed determination criterion in a fast-moving scene controls the number of times the reference frame update processing is performed and suppresses a decrease in encoding efficiency to reduce the calculation processing amount during the encoding processing.

Also in the encoding processing in the second embodiment, the determination based on the statistical determination criterion suppresses a decrease in encoding efficiency and, at the same time, reduces the number of times the reference frame update processing is performed and reduces the calculation processing amount during the encoding processing even in a case in which an input image that is not pre-assumed is received.

As described above, the first embodiment and the second embodiment of the present invention can reduce the calculation processing amount during the encoding processing while suppressing a decrease in encoding efficiency.

In the embodiments of the present invention described above, only a part of the picture structure, indicated as the PB structure or PP structure, can be changed. At this time, however, if the reference frame update frequency is low, it is also possible to prolong the GOP(Group of Picture) period or to prolong the P-picture insertion period. In this case, the encoding is more efficient depending upon the input data.

The encoding processing in the above embodiments has been described as frame-basis encoding processing. However, all embodiments described above can be applied to the field-basis encoding of interlace image signals. That is, for the description of field-basis encoding, “frame” in the description of the embodiments should be replaced by “field”.

The encoding processing method or the encoding apparatus in the embodiments of the present invention described above can also provide a technology for encoding moving image data at a high speed. The encoding method or the encoding apparatus can also provide a moving image encoding technology for encoding moving image data at a high speed while maintaining the image quality.

The encoding processing method or the encoding apparatus described in the embodiments of the present invention described above is efficiently used also for a device or a system for encoding slow-moving videos such as a monitor image or a video conference.

Any of the embodiments described above can be combined as one embodiment of the present invention.

The encoding processing method or the encoding apparatus in the embodiments of the present invention described above can reduce the calculation processing amount during the encoding processing while suppressing a decrease in encoding efficiency.

It should be further understood by those skilled in the art that although the foregoing description has been made on embodiments of the invention, the invention is not limited thereto and various changes and modifications may be made without departing from the spirit of the invention and the scope of the appended claims.

1. An encoding method for use on an encoding apparatus that encodes input image data having a plurality of image frames, said encoding method comprising the steps of:
generating predicted image data from an image of a predetermined reference frame;
generating differential image data from a difference between the predicted image data and image data of one frame of the input image data;
performing discrete cosine transformation processing and quantization processing for the differential image data for generating encoded image data;
performing variable-length encoding processing for the encoded image data for generating an encoded stream; and
performing reference frame update determination processing in which a correlation between the image of the reference frame and the image of said one frame is determined for deciding whether or not said one frame is to be used as a new reference frame.

2. The encoding method according to claim 1 wherein, if said one frame is decided to be a new reference frame in said reference frame update determination processing step, said encoding method further comprises the steps of:
performing inverse quantization processing and inverse discrete cosine transformation processing for the encoded image data for producing differential image data; and
adding up the decoded differential image data and the predicted image data for generating image data of the new reference image frame.

3. The encoding method according to claim 1 wherein the determination processing in said reference frame update determination processing step compares a determination target calculation value with a determination criterion value for determining the image correlation between the reference frame and said one frame, said determination target calculation value being calculated using one of the differential image data, the coded image data, and the encoded stream, said determination criterion value being stored in a memory provided in said encoding apparatus.

4. The encoding method according to claim 3 wherein the determination criterion value is determined based on a determination target calculation value in a frame temporally and immediately following the reference frame.

5. The encoding method according to claim 3 wherein the determination criterion value is determined by performing statistical processing for each of determination target calculation values calculated during the encoding of a plurality of frames temporally before said one frame.

6. The encoding method according to claim 1 wherein
said step for generating predicted image data is a step that selectively uses a forward prediction method or a bi-directional prediction method and
if at least one un-encoded frame, for which no encoding processing is performed, is temporally between the reference frame and said one frame, said encoding method further comprises the step of deciding which predicted-image prediction method, forward prediction or bi-directional prediction, is to be used for encoding the un-encoded frame based on the determination result of said step for performing reference frame update determination processing, and
a predicted image used in encoding the un-encoded frame is generated using the determined prediction method.

7. An encoding apparatus which encodes input image data having a plurality of image frames, comprising:
a predicted image generation unit which generates predicted image data from an image of a predetermined reference frame;
a subtracter which generates differential image data from a difference between the predicted image data and image data of one frame of the input image data;
an encoding processing unit which performs discrete cosine transformation processing and quantization processing for the differential image data for generating encoded image data;
a variable-length encoding processing unit which performs variable-length encoding processing for the encoded image data for generating an encoded stream; and
a reference frame update determination processing unit which determines a correlation between the reference frame and said one frame for deciding whether or not said one frame is to be used as a new reference frame.

8. The encoding apparatus according to claim 7, further comprising:
a decoding processing unit which performs inverse quantization processing and inverse discrete cosine transformation processing for the encoded image data, which is output by said encoding processing unit, for producing differential image data;
an adder which adds up the decoded differential image data and the predicted image data for generating image data of a new reference image frame;
a reference image memory in which the new reference image is stored; and
a switch unit which switches whether or not the differential data is to be sent from said encoding processing unit to said decoding processing unit wherein
if said one frame is decided to be a new reference frame, said reference frame update determination processing unit sends a control signal to said switch unit, said control signal being sent for sending the differential data from said encoding processing unit to said decoding processing unit.

9. The encoding apparatus according to claim 7 wherein the determination processing in said reference frame update determination processing unit compares a determination target calculation value with a determination criterion value for determining the image correlation between the reference frame and said one frame, said determination target calculation value being calculated using one of the differential image data, the coded image data, and the coded stream, said determination criterion value being stored in a memory provided in said encoding apparatus.

10. The encoding apparatus according to claim 9 wherein the determination criterion value is determined based on a determination target calculation value in a frame temporally and immediately following the reference frame.

11. The encoding apparatus according to claim 9 wherein the determination criterion value is determined by performing statistical processing for each of determination target calculation values calculated during the encoding of a plurality of frames temporally before said one frame.

12. The encoding apparatus according to claim 7 wherein
said predicted image generation unit selectively uses a forward prediction method or a bi-directional prediction method and
if at least one un-encoded frame, for which no encoding processing is performed, is temporally between the reference frame and said one frame, said encoding apparatus further comprises a prediction direction determination unit that decides which predicted-image prediction method, forward prediction or bi-directional prediction, is to be used in the encoding processing of the un-encoded frame based on the determination result of said reference frame update determination processing unit, and
said predicted image generation unit generates a predicted image to be used in encoding the un-encoded frame using the prediction method determined by said prediction direction determination unit.

13. An encoding apparatus which encodes input image data having a plurality of image frames, comprising:
a predicted image generation unit which generates predicted image data by selectively using one of an intra-frame prediction method, a forward prediction inter-frame prediction method, and a bi-directional prediction inter-frame prediction; and
an output unit which outputs an encoded stream generated by using the predicted image data and the input image data wherein
at least one set of temporally consecutive two P-pictures, which reference the same frame as a reference frame, is included in the encoded stream output from said output unit wherein a frame encoded by the intra-frame prediction method is an I-picture, a frame encoded by the forward prediction inter-frame prediction method is a P-picture, and a frame encoded by the bi-directional prediction inter-frame prediction method is a B picture.

14. The encoding apparatus according to claim 13 wherein, when a predetermined reference frame forward-predicted by other frames and a plurality of P-picture frames that are not a reference frame of other pictures are temporally contiguous from the reference frame in the encoded stream that is output from said output unit, the plurality of P-picture frames are all encoded by referencing the predetermined reference frame.

15. The encoding apparatus according to claim 13 wherein a frame which immediately follows a frame, which is included in the plurality of P-picture frames and which is temporally the last frame, is a P-picture frame that references the predetermined reference frame.

16. The encoding apparatus according to claim 13 wherein, when one or more B-picture frames temporally and immediately follow a frame which is one of the plurality of P-picture frames and which is temporally the last frame, the one or more B-picture frames all include the predetermined reference frame as at least one of reference frames.

17. The encoding apparatus according to claim 16 wherein, when a P-picture frame immediately follows the one or more B-picture frames, the P-picture frame that immediately follows references the predetermined reference frame.
